(19) United States
(12) Patent Application Publication
(10) Pub. No.: US 2012/0160610 A1
(43) Pub. Date: Jun. 28, 2012

(54) LUBRICANT SUPPLY TUBE FOR COMPRESSORS

(75) Inventors: Chew Thong Khoo, Singapore (SG); Meng Wai, Mooi (SG); Wee Beng Yap, Singapore (SG)

(73) Assignee: PANASONIC CORPORATION, Osaka (JP)

(21) Appl. No.: 13/384,740

(22) PCT Filed: Aug. 24, 2010
(86) PCT No.: PCT/SG2010/000309

§ 371 Date: Jan. 18, 2012

(30) Foreign Application Priority Data
Aug. 27, 2009 (SG) 200905714-2

(51) Int. Cl. F01M 11/02; F01M 9/06; F16N 39/00; F16N 7/36

(52) U.S. Cl. 184/6.21; 184/6; 184/11.2

(57) ABSTRACT

A lubricant supply tube for attachment to a drive shaft of a sealed reciprocating compressor comprising an elongated first portion adapted for extending downwardly from the drive shaft and inclined with respect to a rotational axis of the drive shaft for immersion into a lubricant in a lubricant sump of the compressor, and terminating in a substantially elliptical inlet orifice defining a first plane; and wherein the first plane is inclined with respect to a second plane extending perpendicular to a longitudinal axis of the elongated first portion.

### FIELD OF THE INVENTION

The present invention relates broadly to a lubricant supply tube for attachment to a drive shaft of a sealed reciprocating compressor and to a sealed reciprocating compressor.

### BACKGROUND

Sealed motor-driven compressors are used in many applications, and particularly in refrigeration and air conditioning systems. Such compressors are usually of the piston type and compress the gaseous refrigerant into liquid phase. Such sealed motor-compressors include a sump at the bottom of the sealed casing containing a liquid lubricant such as oil. Frequently, lubricant supply tubes are used in which one end of the tube extends downwardly into the sump at an angle with respect to the axis of rotation. The other end extends vertically upward toward the motor shaft to which it is connected. The motor shaft rotates the lubricant supply tube such that the liquid lubricant is forced upwardly in the tube by centrifugal force so as to be supplied to various moving components of the compressor.

FIG. 1 illustrates a typical prior art supply tube which is more fully disclosed in detail in U.S. Pat. No. 5,088,579. Briefly, tube 1, which is also referred to as an oil pickup tube, is rotated by a motor shaft 4 such that the oil flows upwardly through oil passage 6 which extends through knob 7, crank shaft 5 and into shaft 4. As clearly shown, the plane X defined by the inlet opening 2 of tube 1 is perpendicular to the longitudinal axis Y of the angled portion of the tube.

In this design, the tube 1 is formed by folding a metal sheet into a cylindrical shape with a gap or fissure extending along the length of the tube where the folded portions meet. A vane portion extends across the fissure at about a mid point along the length of the tube, for structural integrity of the folded tube. While noise reduction may be achieved with such a design due to improve of gas release through the fissure, this design suffers from the higher cost of manufacturing the folded tube including the vane portion.

A similar form of oil supply tube is disclosed in U.S. Pat. No. 3,858,685. In this design, the tube is also connected to the crankshaft, and extends downwardly therefrom at an angle with respect to the vertical axis of the motor shaft such that the inlet end of the tube is immersed in the liquid lubricant. The tube again includes a longitudinal fissure, a lower portion having a transversal section with a spinal shape, and the same portion includes a paddle extending radially outward of the tube for forming bubbles in the lubricant. However, again this design suffers from the higher cost of manufacturing the relatively complex design of the tube.

As disclosed in U.S. Pat. No. 5,842,420, it has also been proposed to reduce the noise level of the compressor by providing an angled passage or duct within the crankshaft so as to draw the oil from the sump upwardly by centrifugal force. The lower end of the crankshaft is cut at an angle with respect to the rotational axis of the crankshaft in order to increase the inlet area of the duct, and thereby increase the oil pumping capacity of the duct, and this is said to also reduce the noise level. Integration of the oil pick up into the crankshaft represents a different design solution compared to designs using a separate tube for attachment to the crankshaft for drawing the oil from the sump. However, such integration can reduce the design flexibility as changes in the design require re-design of the entire crankshaft.

While such prior art designs have been relatively effective in lubricating the compressor components which are adjacent to the outlet ports of lubricant passages, they have not been effective in reaching some of the compressor components, such as will be more fully described hereafter.

### SUMMARY

In accordance with a first aspect of the present invention there is provided a lubricant supply tube for attachment to a drive shaft of a sealed reciprocating compressor comprising an elongated first portion adapted for extending downwardly from the drive shaft and inclined with respect to a rotational axis of the drive shaft for immersion into a lubricant in a lubricant sump of the compressor, and terminating in a substantially elliptical inlet orifice defining a first plane; and wherein the first plane is inclined with respect to a second plane extending perpendicular to a longitudinal axis of the elongated first portion.

An angle between the first and second planes may be in the order of about 15 to 50 degrees.

An angle between the first and second planes may be in the order of about 30 to 45 degrees.

The supply tube may include an elongated second portion inclined with respect to the first portion, and in use, the second portion is adapted for connection to the drive shaft.

The elongated second portion may be adapted for connection to an eccentric portion of the drive shaft, and such that the inlet orifice rotates substantially on the rotational axis of the drive shaft.

The elongated second portion may be provided with at least one degassing port on a side closer to the rotational axis of the drive shaft.

The second portion may be adapted for an interference fit with a corresponding lubricant supply passage formed in the drive shaft.

The second portion may be inclined with respect to the first portion, and in use, the second portion is adapted for connection to the drive shaft in a direction parallel to but offset from the rotational axis of the drive shaft.

The lubricant supply tube may be adapted such that lubricant is provided to parts of the compressor due to splashing of the lubricant caused by rotation of the lubricant supply tube in the lubricant sump.

In accordance with a second aspect of the present invention there is provided a sealed reciprocating compressor comprising a lubricant supply tube as defined in the first aspect.

The compressor may be an induction compressor.

The compressor may be an inverter compressor.

### BRIEF DESCRIPTION OF DRAWINGS

Embodiments of the invention will be better understood and readily apparent to one of ordinary skill in the art from the following written description, by way of example only, and in conjunction with the drawings, in which:

FIG. 1 is an illustration of an oil supply tube of the prior art;

FIG. 2 is a cross-sectional view of a sealed motor-compressor unit incorporating the lubricant supply tube according to one embodiment of the invention;

FIG. 3 shows a detail of FIG. 2;

FIG. 4 shows another detail of FIG. 2; and

FIG. 5 is a Table showing one example of the reduction of the compressor noise level achieved by the present invention.

### DETAILED DESCRIPTION

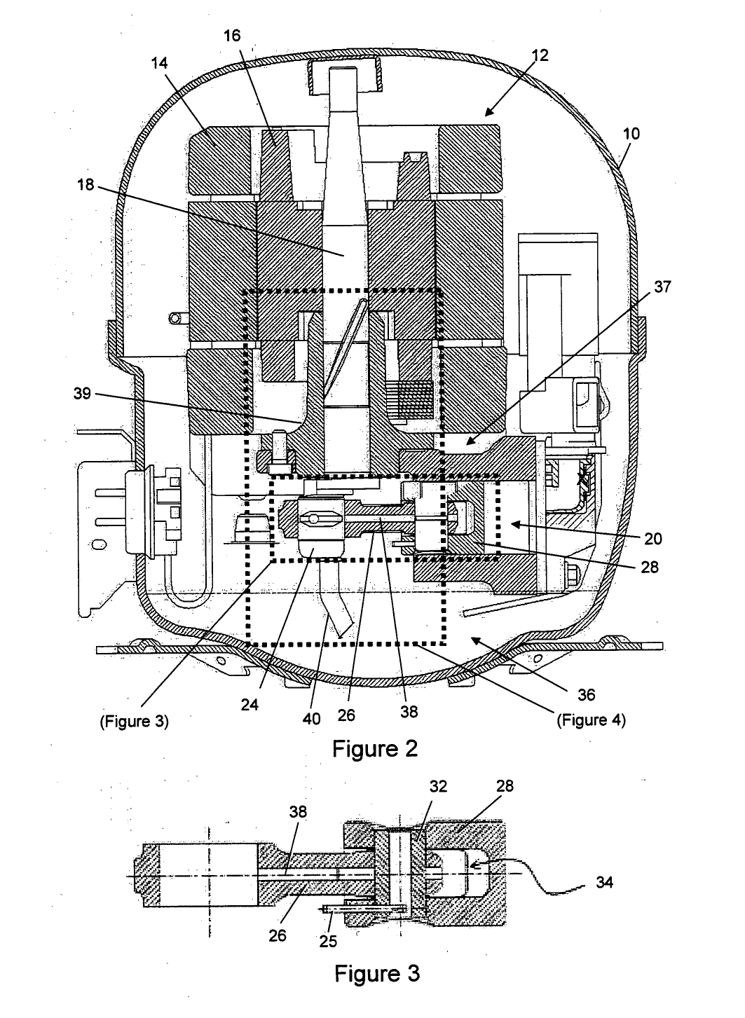

Referring to FIGS. 2 and 3, a motor-driven piston type compressor is illustrated, and it will be readily understood by those skilled in this art that such units include a sealed casing 10 enclosing a motor 12. A cylinder block 37 including the cylinder 20 and a bearing 39 for supporting the drive shaft 18 is provided. Motor 12 includes a stator 14, a rotor 16, and the output drive., shaft 18, configured as an induction compressor supplied with typically either a 50 Hz or 60 Hz power supply.

As also shown in FIG. 2, and in more detail in FIG. 3, shaft 18 comprises an off-set or eccentric portion 24, which in turn, drives connecting rod 26 and piston 28 within cylinder 20. Connecting rod 26 is connected to piston 28 by a bearing in the form of a piston pin 32, which is hollow and secured to the piston 28 by way of a locking pin 25 in this example embodiment. The legs of a U-shaped washer 34 extend between the interior wall of the piston 28 and the outer side surface of rod 26.

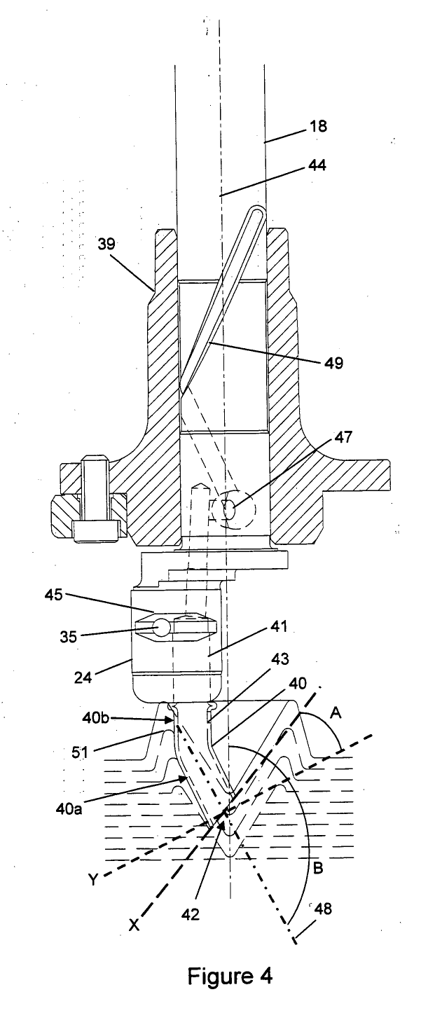

As shown in more detail in FIG. 4, a lubricant supply tube 40 is connected by a vertical straight portion 40b to the lower end of the eccentric portion 24 of the shaft 18 so as to rotate with the tip 42 at the open end of an inclined portion 40a of the tube 40 substantially on the rotational axis 44 of shaft 18. In this example embodiment, the straight portion 40b is attached to the eccentric portion 24 by an interference fit into a corresponding oil supply passage 41 internal to the eccentric portion 24, and extending into the shaft 18.

The inclined portion 40a of the tube 40 extends at an angle, B, with respect to the axis 44 such that a lubricant such as oil from the sump is drawn upwardly within the tube 40 as illustrated in FIG. 4. Preferably the angle, B, of inclination of portion 40a is in the order of about 140 degrees to 170 degrees with respect to the axis 44, and the vertical straight portion 40b includes at least one degassing port 43, on a side closer to the rotational axis 44 of shaft 18.

A lubricant outlet port 35 is formed in a recess or groove 45 on the eccentric portion 24, allowing provision of lubricant via the internal passage 38 formed in the connecting rod 26 and to the piston 28 and piston pin 32 (see FIGS. 2, 3). Another lubricant outlet port 47 is formed at the bottom of the drive shaft 18 and in fluid communication with a helical lubricant passage 49 formed on the surface of the drive shaft 18. The passage 49 terminates above an upper end of the bearing 39 for lubrication during operation of the compressor.

In the example embodiment, parts of the compressor such as U-washer 34 and the sliding surfaces of the piston 28 and connecting rod 26 (see FIGS. 2, 3) are advantageously additionally lubricated by the splashing created by the rapid rotation of the inclined portion 40a of the tube 40.

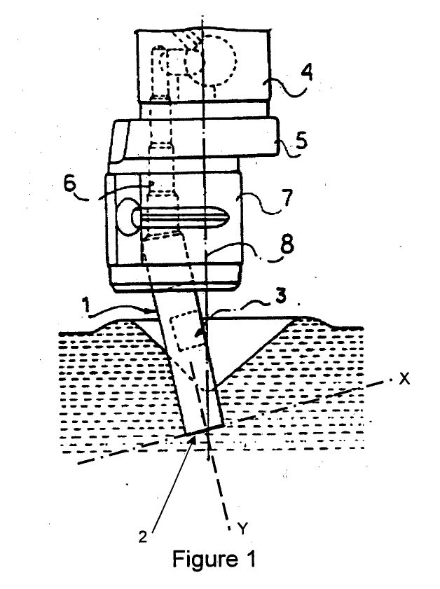

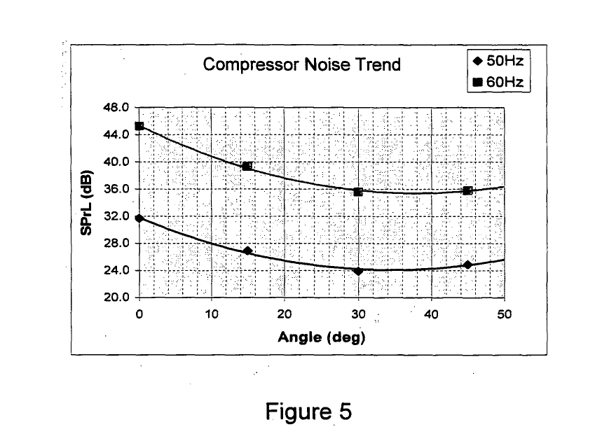

Referring more specifically to FIG. 4, and contrary to the prior art oil supply tubes shown in FIG. 1, the plane “X” defined by the inlet orifice 42 of the tube 40 extends at an angle, A, with respect to a plane “Y” which extends perpendicular to the longitudinal axis 48 of portion 40a of the tube 40. Because of terminating the tube 40 with the inlet orifice 42 at an angle A, it has been found that the noise level of the compressor can be substantially reduced. For example, as shown in Table 1 of FIG. 5, at both 50 Hz & 60 Hz power supply the-decibel levels can be substantially reduced, and a maximum reduction can be achieved with angle A being in the range of about 30 to 45 degrees, measured at the high frequency band.

It has been recognized by the inventors that by selecting the angle A in a range from about 15 to 50 degrees and preferably from about 30 to 45 degrees, the height of the vortex 51 can be increased to an extent sufficient for causing splashing of lubricant to adjacent components, including the U-washer 34 and the sliding surfaces of the piston 28 and connecting rod 26 (see FIGS. 2, 3). It has further been recognized by the inventors that this additional lubrication facilitates noise reduction in the operation of the compressor. This noise reduction is in addition to noise reduction facilitated by foaming of the oil in the sump 36 (see FIG. 2) as a result of the rotation of the tube 40, which improves the sound insulating properties of the oil.

The tube 40 in an example embodiment is made from carbon steel, and advantageously fabricated by tube forming. However, it will be appreciated that the tube can be fabricated from other suitable materials and using different fabrication techniques, in different embodiments.

From the foregoing description of one embodiment of the present invention, it will be apparent that the foregoing objects are achieved regarding both improved lubrication and noise reduction of compressors which are lubricated by the use of lubricant supply tubes drawing lubricant from sumps. It will also be understood that the foregoing description of one embodiment is purely illustrative of the principles of the invention, rather than exhaustive thereof, and that numerous variations of the illustrated embodiment will become apparent to those skilled in the art of compressors.

For example, it will be appreciated that the present invention can be equally applied to inverter compressors in which the speed of the motor can be controlled using signals from a control box, as is understood in the art.

1. A lubricant supply tube for attachment to a drive shaft of a sealed reciprocating compressor comprising:
an elongated first portion adapted for extending downwardly from the drive shaft and inclined with respect to a rotational axis of the drive shaft for immersion into a lubricant in a lubricant sump of the compressor, and terminating in a substantially elliptical inlet orifice defining a first plane; and
wherein the first plane is inclined with respect to a second plane extending perpendicular to a longitudinal axis of the elongated first portion.

2. The lubricant supply tube of claim 1 wherein an angle between the first and second planes is in the order of about 15 to 50 degrees.

3. The lubricant supply tube of claim 2 wherein an angle between the first and second planes is in the order of about 30 to 45 degrees.

4. The lubricant supply tube of claim 1 where the supply tube includes an elongated second portion inclined with respect to the first portion, and in use, the second portion is adapted for connection to the drive shaft.

5. The lubricant supply tube of claim 4, wherein the elongated second portion is adapted for connection to an eccentric portion of the drive shaft, and such that the inlet orifice rotates substantially on the rotational axis of the drive shaft.

6. The lubricant supply tube of claim 4 wherein the elongated second portion is provided with at least one degassing port on a side closer to the rotational axis of the drive shaft.

7. The lubricant supply tube of claim 4, wherein the second portion is adapted for an interference fit with a corresponding lubricant supply passage formed in the drive shaft.

8. The lubricant supply tube of claim 4, the second portion inclined with respect to the first portion, and in use, the second portion is adapted for connection to the drive shaft in a direction parallel to but offset from the rotational axis of the drive shaft.

9. The lubricant supply tube of claim 1, adapted such that lubricant is provided to parts of the compressor due to splashing of the lubricant caused by rotation of the lubricant supply tube in the lubricant sump.

10. A sealed reciprocating compressor comprising a lubricant supply tube of claim 1.

11. The compressor of claim 10, wherein the compressor is an induction compressor.

12. The compressor of claim 10, wherein the compressor is an inverter compressor.

13. The lubricant supply tube of claim 2 where the supply tube includes an elongated second portion inclined with respect to the first portion, and in use, the second portion is adapted for connection to the drive shaft.

14. The lubricant supply tube of claim 3 where the supply tube includes an elongated second portion inclined with respect to the first portion, and in use, the second portion is adapted for connection to the drive shaft.

15. The lubricant supply tube of claim 5 wherein the elongated second portion is provided with at least one degassing port on a side closer to the rotational axis of the drive shaft.

16. The lubricant supply tube of claim 5, wherein the second portion is adapted for an interference fit with a corresponding lubricant supply passage formed in the drive shaft.

17. The lubricant supply tube of claim 5, wherein the second portion is adapted for an interference fit with a corresponding lubricant supply passage formed in the drive shaft.

18. The lubricant supply tube of claim 5, the second portion inclined with respect to the first portion, and in use, the second portion is adapted for connection to the drive shaft in a direction parallel to but offset from the rotational axis of the drive shaft.

19. The lubricant supply tube of claim 6, the second portion inclined with respect to the first portion, and in use, the second portion is adapted for connection to the drive shaft in a direction parallel to but offset from the rotational axis of the drive shaft.

20. The lubricant supply tube of claim 7, the second portion inclined with respect to the first portion, and in use, the second portion is adapted for connection to the drive shaft in a direction parallel to but offset from the rotational axis of the drive shaft.
